(19) United States
(12) Patent Application Publication
(10) Pub. No.: US 2025/0341757 A1
(43) Pub. Date: Nov. 6, 2025

(54) VARIABLE APERTURE MODULE

(71) Applicant: Guangzhou Luxvisions Innovation Technology Limited, Guangzhou City (CN)

(72) Inventor: Cheng-Te TSENG, Guangzhou City (CN)

(21) Appl. No.: 19/008,684

(22) Filed: Jan. 3, 2025

(30) Foreign Application Priority Data
May 6, 2024 (CN) 202410548746.X

(51) Int. Cl. G03B 9/06; G02B 5/00; H04N 23/54

(52) U.S. Cl. CPC G03B 9/06; G02B 5/005; H04N 23/54; G03B 2205/0076

(57) ABSTRACT

The variable aperture module includes a fixing component, a movable component, a shape memory alloy wire, a first clamping component, a second clamping component and a third clamping component. The movable component is movably disposed relative to the fixing component. The shape memory alloy wire has a first wire end and a second wire end. The first clamping component clamps the first wire end. The second clamping component clamps a portion of the shape memory alloy wire other than the first wire end and the second wire end. The third clamping component clamps the second wire end.

This application claims the benefit of People's Republic of China application Serial No. 202410548746.X, filed on May 6, 2024, the subject matter of which is incorporated herein by reference.

### TECHNICAL FIELD

The disclosure relates in general to a variable aperture module.

### BACKGROUND

In current camera modules, a variable aperture structure generally includes a movable component, a fixing component, and a plurality of aperture blades. These aperture blades surround an aperture. The aperture blades are connected to the movable component and the fixing component at two positions respectively. When the movable component and the fixing component rotate relative to each other, these aperture blades rotate and change the size of the aperture surrounded by these aperture blades. How to control the relative rotation of the movable component and the fixing component more quickly and accurately is one of the goals that the industry in this field is working on.

### SUMMARY

The present disclosure provides a variable aperture module capable of resolving the conventional problem.

According to an embodiment, a variable aperture module is provided. The variable aperture module includes a fixing component, a movable component, a shape memory alloy wire, a first clamping component, a second clamping component and a third clamping component. The movable component movably is disposed relative to the fixing component. The shape memory alloy wire has a first wire end and a second wire end. The first clamping component clamps the first wire end. The second clamping component clamps a portion of the shape memory alloy wire other than the first wire end and the second wire end. The third clamping component clamps the second wire end.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1A illustrates a schematic diagram of a movable component of a variable aperture module moving along a first direction according to an embodiment of the present invention;

FIG. 1B illustrates a schematic diagram of the movable component of the variable aperture module in FIG. 1A moving along a second direction;

FIG. 2 illustrates a schematic diagram of a stereoscopic view of a camera lens according to an embodiment of the present invention;

FIGS. 3 and 4 illustrate schematic diagrams of exploded views of the camera lens in FIG. 2;

FIGS. 5 and 6 illustrate schematic diagrams of exploded views of the camera lens in FIG. 2 viewed along different viewing angles;

FIG. 7 illustrates a schematic diagram of a cross-sectional view of the camera lens in FIG. 2 along a direction 7-7′;

FIG. 8A illustrates a schematic diagram of the movable component of the variable aperture module moving along the first direction according to another embodiment of the present invention;

FIG. 8B illustrates a schematic diagram of the movable component of the variable aperture module in FIG. 8A moving along the second direction; and

FIG. 9 illustrates a schematic diagram of a cross-sectional view of a camera lens according to another embodiment of the present invention.

### DETAILED DESCRIPTION

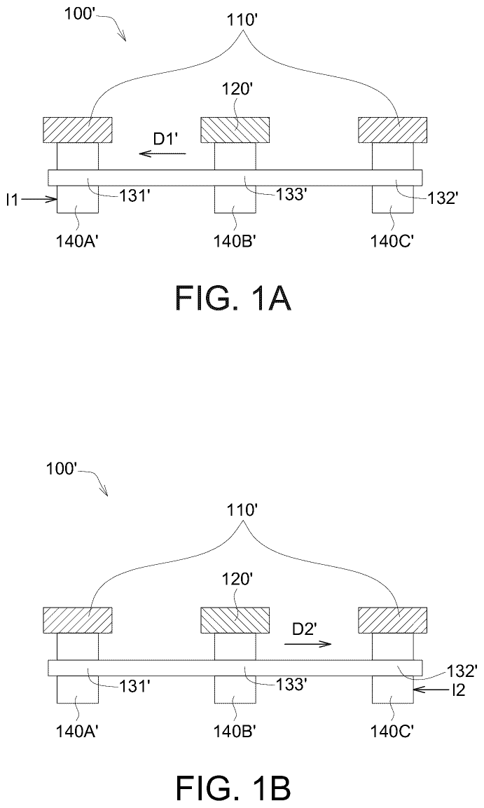

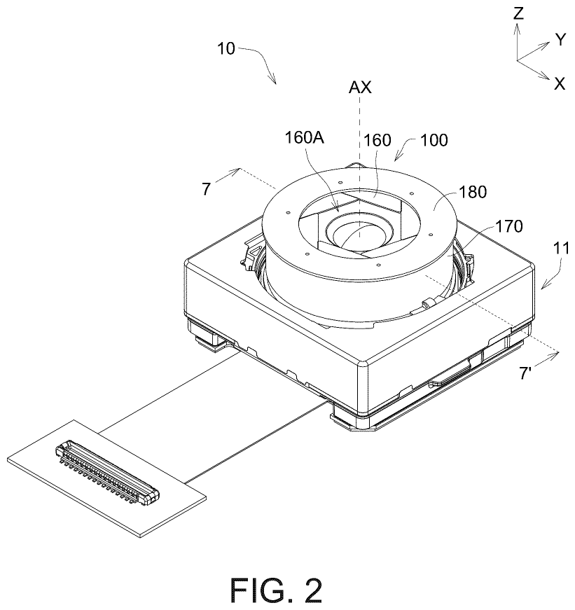

Referring to FIGS. 1A and 1B, FIG. 1A illustrates a schematic diagram of a movable component 120′ of a variable aperture module 100′ moving along a first direction D1′ according to an embodiment of the present invention, and FIG. 1B illustrates a schematic diagram of the movable component 120′ of the variable aperture module 100′ in FIG. 1A moving along a second direction D2′. The variable aperture module 100′ includes a fixing component 110′, a movable component 120′, a shape memory alloy wire (SMA) 130′, a first clamping component 140A′, a second clamping component 140B′ and a third clamping component 140C′.

The fixing component 110′, the movable component 120′, the shape memory alloy wire 130′, the first clamping component 140A′, the second clamping component 140B′ and the third clamping component 140C′ of the present embodiment include the technical features the same as or similar to that of the fixing component 110, the movable component 120, the shape memory alloy wire 130, the first clamping component 140A, the second clamping component 140B and the third clamping component 140C described later, and they will not be repeated here.

As illustrated in FIGS. 1A and 1B, the movable component 120′ is movably disposed relative to the fixing component 110′. The shape memory alloy wire 130′ has a first wire end 131′ and a second wire end 132′. The first clamping component 140A′ clamps the first wire end 131′. The second clamping component 140B′ clamps the portion 133′ of the shape memory alloy wire 130′ other than the first wire end 131′ and the second wire end 132′. The third clamping component 140C′ clamps the second wire end 132′. As a result, in the first control mode, when the first clamping component 140A′ is energized (e.g., applies the first current 11 to the first clamping component 140A′), the length of the shape memory alloy wire 130′ changes (e.g., shortens) to drive the movable component 120′ to rotate, relative to the fixing component 110′, around the first direction D1′, thereby driving the aperture blades (not illustrated in FIGS. 1A and 1B) connected to the movable component 120′ to move for shrinking (or expanding) the aperture. In the second control mode, when the third clamping component 140C′ is energized (e.g., (e.g., applies the second current 12 to the third clamping component 140C′), the length of the shape memory alloy wire 130′ changes (e.g., shortens) for driving the movable component 120′ to move, relative to the fixing component 110′, around the second direction D2′, thereby driving the aperture blades connected to the movable component 120′ to move for expanding (or shrinking) the aperture. The first direction D1′ and the second direction D2′ are two opposite directions. In addition, by controlling the current, the relative rotation of the movable component and the fixing component may be controlled more quickly and accurately.

The characteristic of the shape memory alloy wire 130 of the embodiment of the present invention is that when the shape of the shape memory alloy wire 130 is changed, once it is heated (for example, powered on) to a certain transition temperature, it may be restored to its original (or initial) shape. The shape memory alloy wire 130 may detect and control the length of the shape memory alloy wire 130 after power is turned on according to the change in the resistance value of the wire length, so as to achieve a dead loop control.

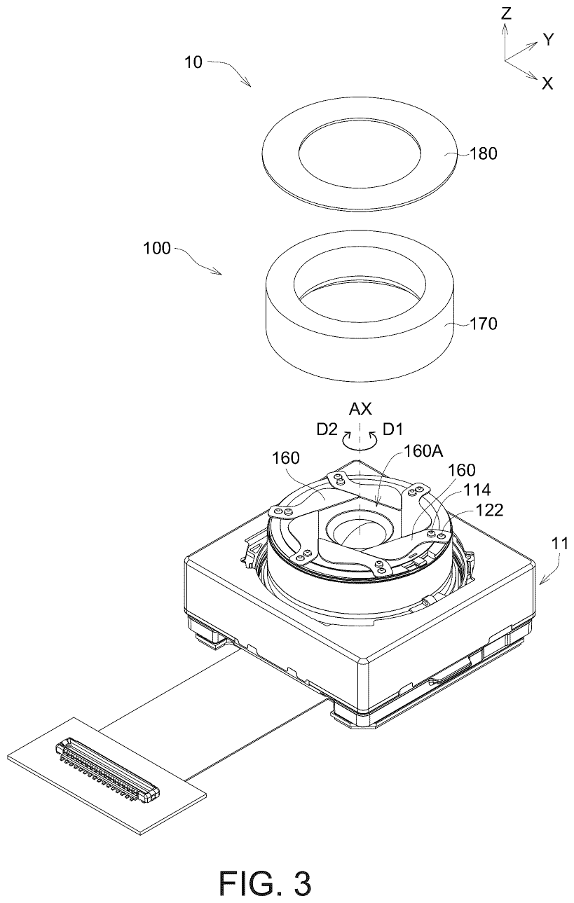

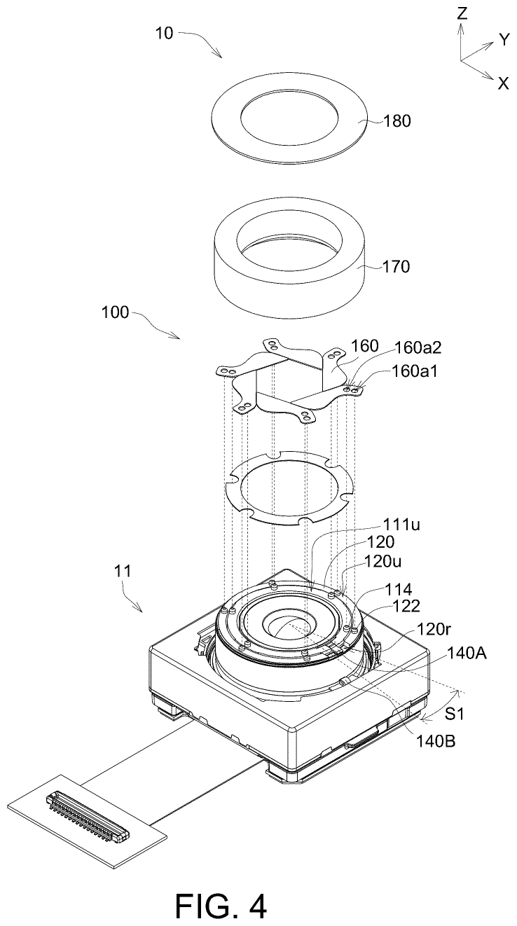

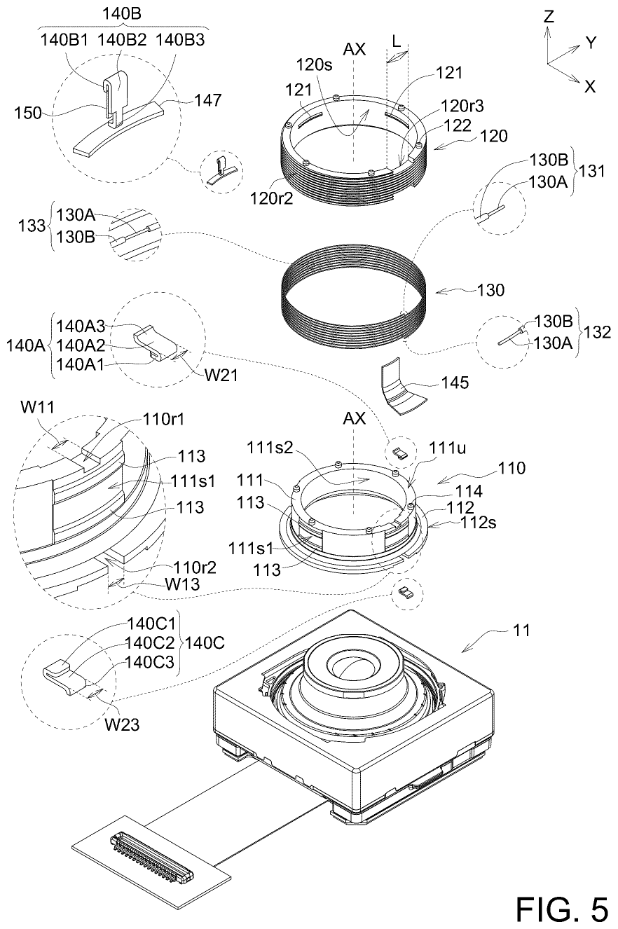

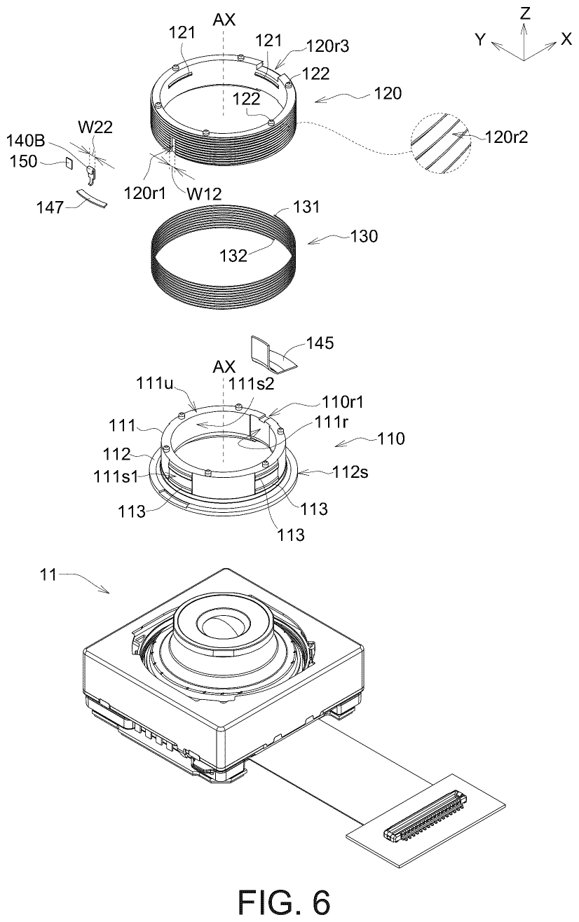

Referring to FIGS. 2 to 7, FIG. 2 illustrates a schematic diagram of a stereoscopic view of a camera lens 10 according to an embodiment of the present invention, FIGS. 3 and 4 illustrate schematic diagrams of exploded views of the camera lens 10 in FIG. 2, FIGS. 5 and 6 illustrate schematic diagrams of exploded views of the camera lens 10 in FIG. 2 viewed along different viewing angles, and FIG. 7 illustrates a schematic diagram of a cross-sectional view of the camera lens 10 in FIG. 2 along a direction 7-7′.

As illustrated in FIGS. 3 to 4, the camera lens 10 includes an optical body 11 and a variable aperture module 100. The variable aperture module 100 is disposed on the optical body 11. Light from the environment may be incident on the optical body 11 through the variable aperture module 100, and the optical body 11 may sense the light and generate a corresponding imaging signal. Although not shown, the optical body 11 may include at least one optical lens, a light sensor, etc., wherein the light may be incident on the light sensor through the optical lens, and the light sensor may sense the light and generate the corresponding imaging signal.

As illustrated in FIGS. 3 to 6, the variable aperture module 100 includes a fixing component 110, a movable component 120, a shape memory alloy wire 130, a first clamping component 140A, a second clamping component 140B, a third clamping component 140C, a circuit board 145, a grounding component 147, an insulation component 150, at least one aperture blade 160, a sleeve 170 and a protective cover 180.

As illustrated in FIGS. 3, 5 and 7, the movable component 120 is movably disposed relative to the fixing component 110. For example, the movable component 120 may rotate relative to the fixing component 110 around a central axis AX, wherein the central axis AX is, for example, parallel to the Z axis. The shape memory alloy wire 130 has a first wire end 131 and a second wire end 132. The first clamping component 140A clamps the first wire end 131. The second clamping component 140B clamps a portion 133 of the shape memory alloy wire 130 other than the first wire end 131 and the second wire end 132. The third clamping component 140C clamps the second wire end 132. As a result, in the first control mode, when the first clamping component 140A is energized, the length of the shape memory alloy wire 130 changes (e.g., shortens) for driving the movable component 120 to rotate, relative to the fixing component 110, around a first direction D1 (the first direction D1 is illustrated in FIG. 3), thereby driving the aperture blades 160 (the aperture blades 160 are illustrated in FIG. 3) connected to the movable component 120 to move for shrinking (or expanding) the aperture. In the second control mode, when the third clamping component 140C is energized, the length of the shape memory alloy wire 130 changes (for example, shortens) for driving the movable component 120 to move toward the second clamping component 140B along the second direction D2 (the second direction D2 is illustrated in FIG. 3), thereby driving the aperture blades 160 connected to the movable component 120 to move for expanding (or shrinking) the aperture. The aforementioned first direction D1 and the second direction D2 are two opposite directions. In an embodiment, the first direction D1 is, for example, counterclockwise, and the second direction D2 is, for example, clockwise. In addition, the aforementioned portion 133 is, for example, a middle position of the shape memory alloy wire 130, but the embodiment of the present invention is not limited thereto.

As illustrated in FIGS. 5 and 6, the fixing component 110 has a first position-limiting groove 110r1 and a third position-limiting groove 110r2, the movable component 120 has a second position-limiting groove 120r1, and the first clamping component 140A, the second clamping component 140B and the third clamping component 140C are respectively disposed in the first position-limiting groove 110r1, the second position-limiting groove 120r1 and the third position-limiting groove 110r2. The degrees of freedom (DoF) of the first clamping component 140A, the second clamping component 140B and the third clamping component 140C are respectively limited by the first position-limiting groove 110r1, the second position-limiting groove 120r1 and the third position-limiting groove 110r2. As a result, when the length of the shape memory alloy wire 130 changes, the second clamping component 140B disposed on the movable component 120 is driven by the shape memory alloy wire 130, thereby driving the movable component 120 to rotate relative to the fixing component 110.

As illustrated in FIGS. 5 to 7, the fixing component 110 includes a body 111 and a flange 112. The body 111 has a first outer peripheral surface 111s1 and an upper surface 111u. The flange 112 is connected to the body 111 and protrudes relative to the first outer peripheral surface 111s1 and has a second peripheral surface 112s. The first position-limiting groove 110r1 is recessed relative to the upper surface 111u, and the first position-limiting groove 110r1 is exposed from the upper surface 111u, so that the first clamping component 140A may be conveniently installed in the first position-limiting groove 110r1 from the side of the upper surface 111u. The third position-limiting groove 110r2 penetrates through the flange 112, and the third clamping component 140C may be partially located in the third position-limiting groove 110r2. In an embodiment, the first clamping component 140A may be fixed in the first position-limiting groove 110r1 by an adhesive layer (not illustrated), and/or the third clamping component 140C may be fixed in the third position-limiting groove 110r2 by an adhesive layer (not illustrated).

In another embodiment, the first clamping component 140A may be tightly fitted (for example, interference fitting) in the first position-limiting groove 110r1, and/or the third clamping component 140C may be tightly fitted (for example, interference fitting) in the third position-limiting groove 110r2.

As illustrated in FIGS. 5 to 7, in an embodiment, the first position-limiting groove 110r1 has a first groove width W11, and the first clamping component 140A has a first width W21, and the first width W21 of the first clamping component 140A is substantially equal to or greater than the first groove width W11 of the first position-limiting groove 110r1, so that the displacement of the first clamping component 140A relative to the first position-limiting groove 110r1 is small or even zero. Similarly, the third position-limiting groove 110r2 has a third groove width W13, and the third clamping component 140C has a third width W23. The third width W23 of the third clamping component 140C is substantially equal to or greater than the third groove width W13 of the third position-limiting groove 110r2, so that the displacement of the third clamping component 140C relative to the third position-limiting groove 110r2 is small or even zero.

As illustrated in FIGS. 5 to 7, the first position-limiting groove 110r1 and the third position-limiting groove 110r2 are disposed along the direction Z (for example, parallel to the central axis AX). In other words, the first position-limiting groove 110r1 and the third position-limiting groove 110r2 overlap along the direction Z. As a result, the first clamping component 140A disposed in the first position-limiting groove 110r1 and the third clamping component 140C disposed in the third position-limiting groove 110r2 may correspond to a small width area of the circuit board 145, so that the width of the circuit board 145 may be designed to be smaller. In another embodiment, the first position-limiting groove 110r1 and the third position-limiting groove 110r2 may not overlap along the direction Z (i.e., the rotation directions of the first position-limiting groove 110r1 and the third position-limiting groove 110r2 around the Z axis are staggered).

As illustrated in FIGS. 6 and 7, the second clamping component 140B may be disposed in the second position-limiting groove 120r1. In an embodiment, the second clamping component 140B is tightly fitted in the second position-limiting groove 120r1. The second position-limiting groove 120r1 has a second groove width W12, and the second clamping component 140B has a second width W22, and the second width W22 of the second clamping component 140B is substantially equal to or greater than the second groove width W12 of the second position-limiting groove 120r1, so that the displacement of the second clamping component 140B relative to the second position-limiting groove 120r1 is small or even zero. In another embodiment, the second clamping component 140B may be fixed in the second position-limiting groove 120r1 by an adhesive layer (not illustrated). There is no relative motion relationship between the second clamping component 140B and the second position-limiting groove 120r1. As a result, when the movable component 120 and the fixing component 110 rotate relative to each other, the second clamping component 140B will not hit the side wall of the second position-limiting groove 120r1 and make a collision noise (if the second clamping component 140B and the second position-limiting groove 120r1 may move relative to each other, the second clamping component 140B will hit the side wall of the second position-limiting groove 120r1 and make the collision noise when being pulled). In addition, since there is no relative motion relationship between the second clamping component 140B and the second position-limiting groove 120r1, the clearance may be eliminated, so that the relative position of the movable component 120 and the fixing component 110 may be more accurately positioned during the relative rotation process.

As illustrated in FIG. 6, the body 111 of the fixing component 110 has an inner peripheral surface 111s2 and a circuit board limiting groove 111r, and the inner peripheral surface 111s2 and the first outer peripheral surface 111s1 are two opposite surfaces of the body 111. The circuit board limiting groove 111r is recessed relative to the inner peripheral surface 111s2 to accommodate the circuit board 145 to prevent the circuit board 145 from interfering with the components inside the fixing component 110 (for example, a part of the optical body 11, for example, a lens).

As illustrated in FIGS. 5 and 7, the movable component 120 includes an inner peripheral surface 120s. The fixing component 110 includes at least one first protrusion 113, and the first protrusion 113 protrudes relative to the first outer peripheral surface 111s1. In an embodiment, a plurality of the first protrusions 113 are separated from each other and surround the central axis AX of the fixing component 110. The first protrusion 113 abuts against the inner peripheral surface 120s. By designing the contact area between the first protrusion 113 and the inner peripheral surface 120s, there is sufficient friction between the movable component 120 and the fixing component 110. As a result, after power is cut off (no power is supplied to the clamping component), the movable component 120 and the fixing component 110 do not easily rotate relative to each other, ensuring that the aperture size remains fixed (after power is cut off, the shape memory alloy wire 130 has a tendency (i.e., the tendency to drive the movable component 120 to rotate) to return to the length of the low temperature state, but the movable component 120 and the fixing component 110 may still remain relatively motionless due to the friction). In other words, due to the effect of friction, the aperture size may still remain fixed when the clamping component is not continuously powered, thereby achieving a power saving effect. However, in another embodiment, if there is no friction, the shape memory alloy wire 130 may also be continuously powered to control the relative position (it may determine the aperture size) of the movable component 120 and the fixing component 110.

In the present embodiment, the number of the first protrusions 113 is eight and, the first protrusions 113 are separated from each other. For example, two first protrusions 113 overlap along the Z axis to form a first protrusion group, and four first protrusion groups are disposed on the first outer peripheral surface 111s1 of the movable component 120. However, in another embodiment, the number of the first protrusions 113 may be single, and the first protrusions 113 surround the central axis AX of the movable component 120 at an angle (for example, 360 degrees or less). By designing the number of the first protrusions 113 and/or the size of the first protrusion 113 (for example, length, width and/or thickness), the contact area may be determined, thereby obtaining the expected friction force between the movable component 120 and the fixing component 110.

As illustrated in FIGS. 5 and 7, the movable component 120 includes at least one second protrusion 121, and the second protrusion 121 protrudes relative to the inner peripheral surface 120s. The first lateral surface 113s of the first protrusion 113 of the fixing component 110 abuts against the second lateral surface 121s of the second protrusion 121. By designing the abutting area between the first lateral surface 113s of the first protrusion 113 and the second lateral surface 121s of the second protrusion 121, there is sufficient friction between the movable component 120 and the fixing component 110. As a result, after power is cut off (no power is supplied to the clamping component), the movable component 120 and the fixing component 110 do not easily rotate relative to each other, ensuring that the aperture size remains fixed (after power is cut off, the shape memory alloy wire 130 has a tendency (i.e., the tendency to drive the movable component 120 to rotate) to return to the length of the low temperature state, but the movable component 120 and the fixing component 110 may still remain relatively motionless due to the friction). In the present embodiment, the number of the second protrusions 121 is four, and the second protrusions 121 are separated from each other. However, in another embodiment, the number of the second protrusions 121 may be single, and the second protrusions 121 surround the central axis AX of the movable component 120 by an angle (for example, 360 degrees or less). By designing the number of second protrusions 121 and/or the size of the second protrusion 121 (for example, length, width and/or thickness), the abutment area may be determined, thereby obtaining the expected friction force between the movable component 120 and the fixing component 110.

As illustrated in FIGS. 5 and 7, the movable component 120 further has a lower surface 120b, and the flange 112 of the fixing component 110 further has an upper surface 112u, and the upper surface 112u abuts against the lower surface 120b. By designing the abutting area between the upper surface 112u and the lower surface 120b, there is sufficient friction between the upper surface 112u and the lower surface 120b. As a result, after power is cut off (no power is supplied to the clamping component), the movable component 120 and the fixing component 110 do not easily rotate relative to each other, ensuring that the aperture size remains fixed (after power is cut off, the shape memory alloy wire 130 has a tendency (i.e., the tendency to drive the movable component 120 to rotate) to return to the length of the low temperature state, but the movable component 120 and the fixing component 110 may still remain relatively motionless due to the friction).

As illustrated in FIGS. 5 and 7, the movable component 120 has an outer peripheral surface 120s, and the shape memory alloy wire 130 may be wrapped around the outer peripheral surface 120s for at least one circle (or turn). Every time the shape memory alloy wire 130 is wound around the outer peripheral surface 120s, the rotational stroke of the movable component 120 is doubled. The movable component 120 has a groove 120r2, and the groove 120r2 may surround the central axis AX of the movable component 120 for at least one circle. The shape memory alloy wire 130 may be disposed in the groove 120r2, so that the shape memory alloy wire 130 may be correspondingly wrapped around the outer peripheral surface 120s of the movable component 120 for at least one circle. In an embodiment, the outer peripheral surface 120s has at least one circle of concave portions which constitute the aforementioned groove 120r2. The embodiment of the present invention does not limit the number of circles of the shape memory alloy wire 130 around the outer peripheral surface 120s, and it may be determined by the range of variation of the aperture size.

As illustrated in FIGS. 5 and 7, the movable component 120 has a slide groove 120r3, and the slide groove 120r3 has a groove length L (for example, an arc length around the central axis AX), and the first clamping component 140A may be slidably disposed in the slide groove 120r3. In an embodiment, the groove length L of the slide slot 120r3 is greater than the first width W21 of the first clamping component 140A. As a result, the movable component 120 may slide by a stroke S1 relative to the first clamping component 140A (the stroke S1 is illustrated in FIG. 4), and the stroke S1 is the rotation stroke (angle) of the movable component 120 around the central axis AX, and such rotation stroke is, for example, equal to or less than 30 degrees. In an embodiment, the rotation stroke may be greater than the stroke required for the variable aperture to actuate.

As illustrated in FIGS. 5 and 7, the shape memory alloy wire 130 includes a conductive wire body 130A and an insulation layer 130B. Except for the portion clamped by the clamping component, the insulation layer 130B covers the conductive wire body 130A. Furthermore, the first wire end 131 exposes the conductive wire body 130A which is clamped by the first clamping component 140A and electrically connected to the first clamping component 140A. The second wire end 132 exposes the conductive wire body 130A which is clamped by the third clamping component 140C and electrically connected to the third clamping component 140C. The portion 133 exposes the conductive wire body 130A which is clamped by the second holder 140B and electrically connected to the second holder 140B. In addition, when the shape memory alloy wire 130 is wound around the outer peripheral surface 120s of the movable component 120 without being powered on, it may be in a deformed state. After power is applied, the shape memory alloy wire 130 has a tendency to restore the initial state (for example, the length changes). In an embodiment, the shape memory alloy wire 130 will shorten when powered (heated) and will lengthen when not powered (cooled).

As illustrated in FIGS. 5 to 7, the first clamping component 140A includes a first portion 140A1, a second portion 140A2 and a third portion 140A3 connected to each other, and the second portion 140A2 connects the first portion 140A1 with the third portion 140A3. The conductive wire 130A exposed from the first wire end 131 may be clamped between the first portion 140A1 and the second portion 140A2. At least two of the first portion 140A1, the second portion 140A2 and the third portion 140A3 are, for example, integrally formed structures. In terms of manufacturing process, a plate material may be bent or stamped to form the first clamping component 140A. In terms of material, the first clamping component 140A is, for example, formed of a conductive material, such as aluminum, copper, iron or an alloy thereof. In an embodiment, as illustrated in FIG. 7, the third portion 140A3 is adjacent to the circuit board 145. The variable aperture module 100 further includes at least one solder joint P1 which connects the third portion 140A3 with the circuit board 145 to electrically connect the first clamping component 140A with the circuit board 145. A controller (not illustrated) may be electrically connected to the first clamping component 140A through the circuit board 145 and the solder joint P1 to supply a first current to the shape memory alloy wire 130 through the first clamping component 140A.

As illustrated in FIGS. 5 to 7, the second clamping component 140B includes a first portion 140B1, a second portion 140B2 and a third portion 140B3 connected to each other, and the second portion 140B2 connects the first portion 140B1 with the third portion 140B3. At least two of the first portion 140B1, the second portion 140B2 and the third portion 140B3 are, for example, integrally formed structures. In terms of the process, a plate material may be bent or stamped to form the second clamping component 140B. In terms of materials, the clamping component 140A is, for example, formed of a conductive material, such as aluminum, copper, iron or an alloy thereof. The conductive wire 130A exposed by the portion 133 between the first wire end 131 and the second wire end 132 may be clamped between the first portion 140B1 and the second portion 140B2. In an embodiment, as illustrated in FIG. 7, the third portion 140B3 abuts against the grounding component 147, so that the portion 133 of the shape memory alloy wire 130 may be electrically connected to the grounding component 147 through the second clamping component 140B.

As illustrated in FIGS. 5 to 7, the third clamping component 140C includes a first portion 140C1, a second portion 140C2, and a third portion 140C3 connected to each other, and the second portion 140C2 connects the first portion 140C1 with the third portion 140C3. At least two of the first portion 140C1, the second portion 140C2, and the third portion 140C3 are, for example, integrally formed structures. In terms of the manufacturing process, a plate material may be bent or stamped to form the third clamping component 140C. In terms of materials, the third clamping component 140C is, for example, formed of a conductive material, such as aluminum, copper, iron or an alloy thereof. The conductive wire body 130A exposed from the second wire end 132 may be clamped between the first portion 140C1 and the second portion 140C2. The variable aperture module 100 further includes at least one solder joint P2 which connects the third portion 140C3 with the circuit board 145. A controller (not shown) may be electrically connected to the third clamping component 140C through the circuit board 145 and the solder joint P2 to supply a second current to the shape memory alloy wire 130 through the third clamping component 140C.

The aforementioned solder joint is, for example, solder paste or solder.

As illustrated in FIGS. 5 to 7, the circuit board 145 extends from the inner peripheral surface 111s2 to protrude relative to the second outer peripheral surface 112s of the flange 112. In an embodiment, the circuit board 145 is, for example, a flexible circuit board. The circuit board 145 is electrically connected to the first wire end 131 and the second wire end 132. For example, the circuit board 145 may be electrically connected to the first wire end 131 through the clamping component 140A and electrically connected to the second wire end 132 through the third clamping component 140C. The circuit board 145 may transmit current to one of the first wire end 131 and the second wire end 132. For example, in the first control mode, the circuit board 145 may transmit the first current to the first wire end 131. In the second control mode, the circuit board 145 may transmit the second current to the second wire end 132. The value of the first current and/or the value of the second current may depend on the required (or desired) aperture size, and the embodiment of the present invention is not limited. The first control mode and the second control mode may be executed at different times.

As illustrated in FIGS. 5 to 7, the grounding component 147 is disposed between the movable component 120 and the second clamping component 140B and is electrically connected to the second clamping component 140B. The grounding component 147 is electrically connected to a ground potential (not illustrated), so that the second clamping component 140B is grounded through the grounding component 147.

As illustrated in FIGS. 5 to 7, the insulation component 150 is disposed between the second clamping component 140B and the shape memory alloy wire 130 to isolate the second clamping component 140B from the shape memory alloy wire 130, thereby preventing at least one circle (the circle except for the portion 133) of the shape memory alloy wire 130 from being electrically short-circuited with the second clamping component 140B. Furthermore, although the conductive wire 130A of the shape memory alloy wire 130 is coated with the insulation layer 130B, under long-term friction (relative sliding between the shape memory alloy wire 130 and the movable component 120), the insulation layer 130B may be damaged and results in the conductive wire 130A being exposed. Since the insulation component 150 is disposed between the second clamping component 140B and the shape memory alloy wire 130, further protection may be provided against the aforementioned “electrical short-circuit problem”.

As illustrated in FIGS. 3 to 4, a plurality of aperture blades 160 surround an aperture 160A, and the movement of these aperture blades 160 may determine the area of the aperture. The area of the aperture determines the luminous flux. As illustrated in FIG. 4, each aperture blade 160 has a first connection hole 160a1 and a second connection hole 160a2, and the movable component 120 further includes at least one first connection column 122 which is disposed on the upper surface 120u of the movable component 120 and protrudes relative to the upper surface 120u. The fixing component 110 further includes at least one second connection column 114 which is disposed on the upper surface 111u of the fixing component 110 and protrudes relative to the upper surface 111u. The first connection hole 160a1 of each aperture blade 160 is connected to the corresponding first connection column 122, and the second connection hole 160a2 of each aperture blade 160 is connected to the corresponding second connection column 114. When the movable component 120 rotates relative to the fixing component 110 around the central axis AX, the rotation point of each aperture blade 160 (for example, a connection point between the first connection hole 160a1 and the first connection column 122) rotates around the pivot point (for example, a connection point between the second connection hole 160a2 and the second connection column 114), thereby driving each aperture blade 160 to rotate around the pivot point to change the area of the aperture 160A.

As illustrated in FIGS. 3 and 4, the sleeve 170 surrounds the movable component 120 to protect the movable component 120. The protective cover 180 covers the sleeve 170.

Although the shape memory alloy wire 130 of the above embodiment is described as one, this is not intended to limit the embodiment of the present invention. In another embodiment, the number of shape memory alloy wires 130 may be multiple, for example, two.

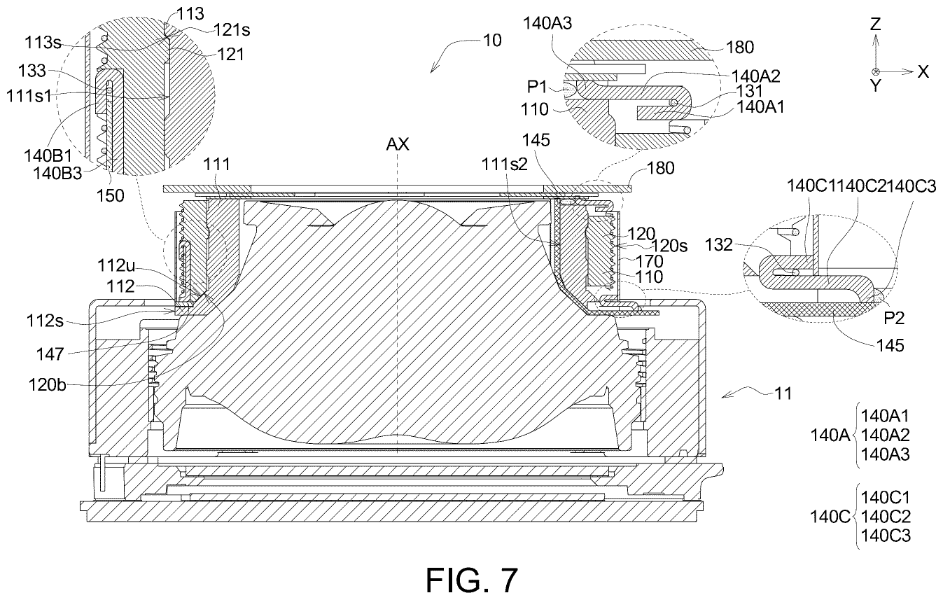

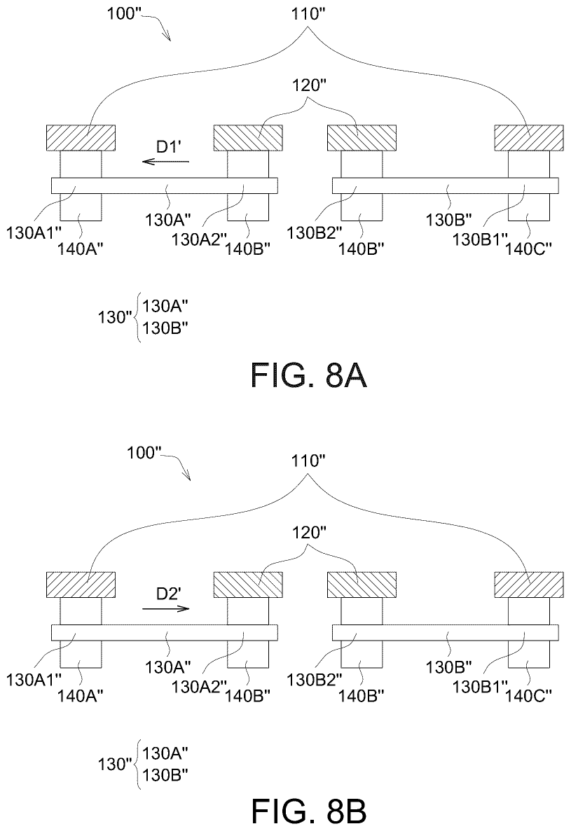

Referring to FIGS. 8A and 8B, FIG. 8A illustrates a schematic diagram of the movable component 120″ of the variable aperture module 100″ moving along the first direction D1′ according to another embodiment of the present invention, and FIG. 8B illustrates a schematic diagram of the movable component 120″ of the variable aperture module 100″ in FIG. 8A moving along the second direction D2′. The variable aperture module 100″ includes a fixing component 110″, a movable component 120″, a shape memory alloy wire 130″, a first clamping component 140A″, two second clamping components 140B″ and a third clamping component 140C″.

The fixing component 110″, the movable component 120″, the shape memory alloy wire 130″, the first clamping component 140A″, the second clamping component 140B″ and the third clamping component 140C″ of the present embodiment have the technical features the same as or similar to that of the aforementioned fixing component 110, the movable component 120, the shape memory alloy wire 130, the first clamping component 140A, the second clamping component 140B and the third clamping component 140C, and they will not be repeated here.

As illustrated in FIGS. 8A and 8B, the movable component 120″ is movably disposed relative to the fixing component 110″. The shape memory alloy wire 130″ includes a first segment 130A″ and a second segment 130B″ separated from the first segment 130A″, wherein the first segment 130A″ has a first wire end 130A1″ and a third wire end 130A2″, and the second segment 130B″ has a second wire end 130B1″ and a fourth wire end 130B2″. The first clamping component 140A″ clamps the first wire end 130A1″ of the first segment 130A″. The two second clamping components 140B″ respectively clamp the third wire end 130A2″ of the first segment 130A″ and the fourth wire end 130B2″ of the second segment 130B″. The third clamping component 140C″ clamps the second wire end 130B1″ of the second segment 130B″. Thus, in the first control mode, when the clamping component 140A″ is energized, the length of the first segment 130A″ of the shape memory alloy wire 130′ changes (e.g., shortens) for driving the movable component 120′ to rotate relative to the fixing component 110′ in the first direction D1′, thereby driving the aperture blades (not illustrated in FIGS. 8A and 8B) connected to the movable component 120′ to move for shrinking (or expanding) the aperture. In the second control mode, when the third clamping component 140C″ is energized, the length of the second segment 130B″ of the shape memory alloy wire 130″ changes (e.g., shortens) for driving the movable component 120′ to move relative to the fixing component 110′ in the second direction D2′, thereby driving the aperture blades connected to the movable component 120′ to move for expanding (or shrinking) the aperture. The first direction D1′ and the second direction D2′ are two opposite directions. Since the first segment 130A″ is separated from the second segment 130B″, in the first control mode, the current applied to the first segment 130A″ and/or the temperature of the first segment 130A″ have little or no effect on the second segment 130B″. Similarly, since the first segment 130A″ is separated from the second segment 130B″, in the second control mode, the current applied to the second segment 130B″ and/or the temperature of the second segment 130B″ have little or no effect on the first segment 130A″.

In an embodiment, two second clamping components 140B″ are disposed adjacent to each other. For example, the two second clamping components 140B″ are disposed approximately adjacent to the label position of the aforementioned movable component 120. Correspondingly, the movable component 120″ has two second position-limiting grooves 120r1 to accommodate the two second clamping components 140B″ respectively.

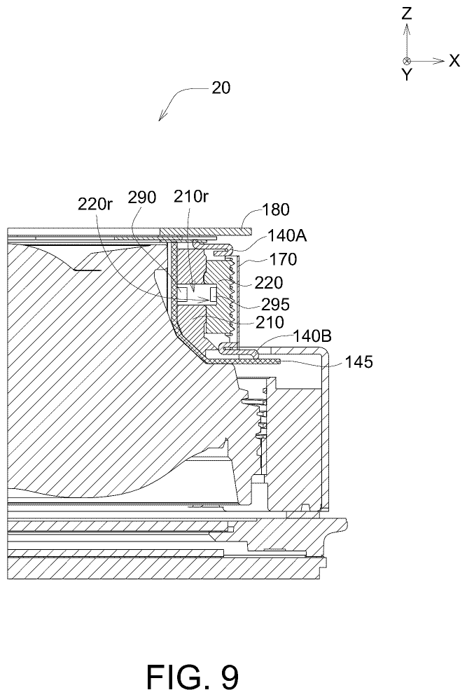

Referring to FIG. 9, FIG. 9 illustrates a schematic diagram of a cross-sectional view of a camera lens 20 according to another embodiment of the present invention.

As illustrated in FIG. 9, the camera lens 20 includes the optical body 11 and a variable aperture module 200. The variable aperture module 200 is disposed on the optical body 11. The variable aperture module 200 includes a fixing component 210, a movable component 220, the shape memory alloy wire 130, the first clamping component 140A, the second clamping component 140B (not illustrated), the third clamping component 140C, the circuit board 145, the grounding component 147 (not illustrated), the insulation component 150 (not illustrated), at least one aperture blade 160 (not illustrated), the sleeve 170, the protective cover 180, a Hall sensor 290 and a magnet 295.

The variable aperture module 200 includes technical features the same as or similar to that of the aforementioned variable aperture module 100, and at least one difference is that the variable aperture module 200 further includes the Hall sensor 290 and the magnet 295.

As illustrated in FIG. 9, the Hall sensor 290 may be disposed and electrically connected to the circuit board 145. The magnet 295 may be disposed on the movable component 220 and may emit a magnetic field (not illustrated). When the movable component 220 and the fixing component 210 rotate relative to each other, the Hall sensor 290 may sense the change in the magnetic field and accordingly determine the relative rotation angle of the movable component 220 and the fixing component 210.

As illustrated in FIG. 9, the fixing component 210 has a recess 210r to accommodate the Hall sensor 290. In the present embodiment, the recess 210r may be a through hole. In another embodiment, the recess 210r is a groove, that is, the recess 210r does not penetrate the fixing component 210. The movable component 220 has a recess 220r to accommodate the magnet 295. In this embodiment, the recess 210r is a groove, that is, the recess 210r does not penetrate the fixing component 210. In another embodiment, the recess 210r may be a through hole.

In summary, an embodiment of the present invention provides a variable aperture module which at least includes a movable component, a fixing component and at least one shape memory alloy wire. The shape memory alloy wire has a first wire end and a second wire end, the first wire end and the second wire end may be connected to or fixed to the fixing component, and a portion between the first wire end and the second wire end of the shape memory alloy wire may be connected to or fixed to the movable component. As a result, when the first wire end is energized, the movable component rotates relative to the fixing component around a first direction. When the second wire end is energized, the movable component rotates relative to the fixing component around a second direction. By controlling the current, the relative rotation of the movable component and the fixing component may be controlled more quickly and accurately. In an embodiment, the first wire end may be fixed to the fixing component by a first clamping component, the second wire end may be fixed to the fixing component by a third clamping component, and a portion between the first wire end and the second wire end of the shape memory alloy wire may be fixed to the movable component by a second clamping component. In an embodiment, the shape memory alloy wire may be split into two separate wire segments so as to be independently controlled to avoid or reduce the degree of influence of the temperature and/or deformation of one of the two wire segments on the temperature and/or deformation of the other of the two wire segments.

It will be apparent to those skilled in the art that various modifications and variations could be made to the disclosed embodiments. It is intended that the specification and examples be considered as exemplary only, with a true scope of the disclosure being indicated by the following claims and their equivalents.

What is claimed is:

1. A variable aperture module, comprising:
a fixing component;
a movable component movably disposed relative to the fixing component;
a shape memory alloy wire having a first wire end and a second wire end;
a first clamping component clamping the first wire end;
a second clamping component clamping a portion of the shape memory alloy wire other than the first wire end and the second wire end; and
a third clamping component clamping the second wire end.

2. The variable aperture module according to claim 1, wherein the fixing component has a first position-limiting groove and a third position-limiting groove, the movable component has a second position-limiting groove, and the first clamping component, the second clamping component and the third clamping component are disposed in the first position-limiting groove, the second position-limiting groove and the third position-limiting groove respectively.

3. The variable aperture module according to claim 2, comprising:
a body having an outer peripheral surface and an upper surface; and
a flange connected to the body and protruding relative to the outer peripheral surface;
wherein the first position-limiting groove is recessed relative to the upper surface, and the third position-limiting groove penetrates the flange.

4. The variable aperture module according to claim 2, wherein the first position-limiting groove and the third position-limiting groove are disposed along an extension direction of a central axis.

5. The variable aperture module according to claim 1, wherein the first clamping component comprises a first portion and a second portion connected to the first portion, and the first wire end is clamped between the first portion and the second portion.

6. The variable aperture module according to claim 1, further comprising:
a circuit board electrically connected to the first clamping component and the third clamping component.

7. The variable aperture module according to claim 6, wherein the fixing component has an inner peripheral surface and a circuit board limiting groove, and the circuit board limiting groove is recessed relative to the inner peripheral surface to accommodate the circuit board.

8. The variable aperture module according to claim 1, further comprising:
a circuit board electrically connected to the first wire end and the second wire end and configured to:
transmit a current to one of the first wire end and the second wire end.

9. The variable aperture module according to claim 1, wherein the fixing component further comprises:
a body having a first outer peripheral surface and an inner peripheral surface; and
a flange protruding relative to the first outer peripheral surface and having a second outer peripheral surface;
wherein the variable aperture module further comprises a circuit board, and the circuit board extends from the inner peripheral surface to protrude beyond the second outer peripheral surface.

10. The variable aperture module according to claim 1, wherein the shape memory alloy wire comprises:
a conductive wire body; and
an insulation layer covering the conductive wire body;
wherein the first wire end, the second wire end and the portion expose the conductive wire body.

11. The variable aperture module according to claim 1, wherein the movable component has an outer peripheral surface, and the shape memory alloy wire is wound around the outer peripheral surface for a plurality of circles.

12. The variable aperture module according to claim 1, wherein the movable component has a groove, the groove surrounds a central axis of the movable component for a plurality of circles, and the shape memory alloy wire is disposed in the groove.

13. The variable aperture module according to claim 1, wherein the movable component comprises an inner peripheral surface; the fixing component comprises an outer peripheral surface and a first protrusion, the first protrusion protrudes relative to the outer peripheral surface, and the first protrusion abuts against the inner peripheral surface.

14. The variable aperture module according to claim 13, wherein the fixing component comprises a plurality of the first protrusions, the first protrusions are separated from each other and surround a central axis of the movable component.

15. The variable aperture module according to claim 1, wherein the movable component comprises an inner peripheral surface and a second protrusion, the second protrusion protrudes relative to the inner peripheral surface; the fixing component comprises an outer peripheral surface and a first protrusion, the first protrusion protrudes relative to the outer peripheral surface, and a first lateral surface of the first protrusion abuts against a second lateral surface of the second protrusion.

16. The variable aperture module according to claim 15, wherein the movable component has a lower surface, the fixing component has an upper surface, and the upper surface abuts against the lower surface.

17. The variable aperture module according to claim 1, wherein the variable aperture module further comprises:
a grounding component disposed between the movable component and the second clamping component and electrically connected to the second clamping component.

18. The variable aperture module according to claim 1, wherein the movable component has a slide groove, the slide groove has a groove length, the first clamping component is slidably disposed in the slide groove, the first clamping component has a width, and the groove length is greater than the width.

19. The variable aperture module according to claim 1, further comprising:
an insulation component separating the second clamping component from the shape memory alloy wire.

20. The variable aperture module according to claim 1, wherein the shape memory alloy wire comprises a first segment and a second segment separated from the first segment, the first segment has the first wire end and a third wire end, and the second segment has the second wire end and a fourth wire end;
wherein the first clamping component clamps the first wire end of the first segment, two second clamping components clamp the third wire end of the first segment and the fourth wire end of the second segment respectively, and the third clamping component clamps the second wire end of the second segment.
